(19) United States
(12) Patent Application Publication
(10) Pub. No.: US 2026/0184285 A1
(43) Pub. Date: Jul. 2, 2026

(54) SEATBACK

(71) Applicants: TS TECH CO., LTD., Asaka-shi (JP); HONDA MOTOR CO., LTD., Tokyo (JP)

(72) Inventors: Takahiro INABA, Tochigi (JP); Masaru TAKAGI, Tochigi (JP); Naomichi FUKUDA, Tochigi (JP); Naofumi KOBAYASHI, Tochigi (JP); Manabu MATSUMOTO, Tokyo (JP)

(21) Appl. No.: 19/429,288

(22) Filed: Dec. 22, 2025

(30) Foreign Application Priority Data
Dec. 26, 2024 (JP) 2024-231391

(51) Int. Cl. B60R 22/34; B60N 2/64

(52) U.S. Cl. CPC B60R 22/34; B60N 2/64; B60R 2022/3402

(57) ABSTRACT

A seatback includes: a seatback frame; a first belt guide which has a first end and a second end supported on the seatback frame at positions spaced from each other in a width direction of the seatback frame and guides a belt withdrawn from a seat belt retractor; and a support member supporting an intermediate portion of the first belt guide between the first end and the second end from below.

### TECHNICAL FIELD

The present invention relates to a seatback.

### BACKGROUND ART

JP2024-83194A discloses a seatback frame of a vehicle seat. The seatback frame forms a skeleton of the seatback serving as a backrest and is covered by a pad member made of cushioning material and a skin member. The seatback frame is provided with a pipe frame, a back panel frame, a support bracket for a seat belt retractor, a mounting bracket for a lock device, a first belt guide and a second belt guide for guiding the seat belt withdrawn from the seat belt retractor, etc. The pipe frame includes a first pipe member having a left frame part, a right frame part, and an upper frame part, and the first belt guide and the second belt guide are mounted to the upper frame part of the first pipe member. Each of the first belt guide and the second belt guide is composed of a wire formed in a substantially U shape, and a pair of arm parts formed by two end portions of each wire are bent in an arc shape and are joined to the peripheral surface of the upper frame part by welding.

In the seatback frame of JP2024-83194A, each of the first belt guide and the second belt guide is joined to the peripheral surface of the upper frame part only at the arc-shaped portion of the pair of arm parts, and it is desired to improve the support stiffness of the belt guide.

### SUMMARY OF THE INVENTION

In view of the foregoing background, an object of the present invention is to provide a seatback in which the support stiffness of the belt guide is improved.

To achieve the above object, one aspect of the present invention provides a seatback (5), comprising: a seatback frame (12R); a first belt guide (51) which has a first end (51a) and a second end (51b) supported on the seatback frame at positions spaced from each other in a width direction of the seatback frame and guides a belt (41) withdrawn from a seat belt retractor (42); and a support member (53) supporting an intermediate portion (51d) of the first belt guide between the first end and the second end from below.

According to this aspect, since the intermediate portion of the first belt guide is supported by the support member from below, the support stiffness of the first belt guide is improved. Therefore, a seatback in which the support stiffness of the first belt guide is improved can be provided.

In the above aspect, the support member may have a first fixing part (53a) and a second fixing part (53b) which are fixed to the seatback frame at positions spaced from each other in the width direction, the first fixing part is disposed more outward in the width direction than the first end of the first belt guide, and the second fixing part is disposed more outward with respect to the intermediate portion in the width direction than the second end of the first belt guide.

According to this aspect, since the support stiffness of the support member is improved, the support stiffness of the first belt guide supported by the support member is also improved.

In the above aspect, the support member may comprise: a wire member (54) including a first wire part (54a) and a second wire part (54b) extending in at least a vertical direction and a connecting wire part (54d) extending in at least the width direction and connecting the first wire part and the second wire part; and a connecting bracket (55) connecting the first wire part and the second wire part.

Here, extending “in at least the vertical direction” means that the extension direction of each wire part has a vertical component, and does not limit the extension direction of each wire part to the vertical direction. Also, extending “in at least the width direction” means that the extension direction of the connecting wire part has a component in the width direction, and does not limit the extension direction of the connecting wire part to the width direction. According to this aspect, due to the use of the wire member, the weight of the support member can be reduced, and due to the use of the connecting bracket, the stiffness of the support member can be improved.

In the above aspect, the connecting bracket may be connected to the first belt guide.

According to this aspect, the support stiffness of the first belt guide is further improved.

In the above aspect, the connecting bracket may include a fixing part (55b) that fixes an exterior cover (8, 11) of the seatback.

According to this aspect, the connecting bracket also functions as a fixing member for fixing the garnish in addition to as a reinforcement member for the support member. Therefore, it is unnecessary to separately provide a fixing member for the garnish, and an increase in the number of components can be suppressed.

In the above aspect, the seatback frame may be formed commonly for a center seat (2C) which is a seat on which the belt is to be fastened and for which the first belt guide is disposed in a position offset from a seat center in the width direction and a side seat (2R) disposed on a side of the center seat to which the first belt guide is offset, the seatback frame may include a headrest support (36) that supports a headrest (7R) of the side seat, and the connecting bracket may be connected to the headrest support.

According to this aspect, since the first belt guide is connected to the headrest support via the connecting bracket, the support stiffness of the first belt guide is further improved.

In the above aspect, lower ends of the first fixing part and the second fixing part of the support member are disposed in positions lower than an upper end of the seat belt retractor.

According to this aspect, the seat belt retractor is disposed in a high position overlapping the support member in the height direction. Thereby, the seatback can be made compact.

In the above aspect, the first belt guide may be made of a wire and the first end and the second end of the first belt guide may be bent to extend in the width direction along the seatback frame.

According to this aspect, even though the first belt guide is made of a wire, the first belt guide can be fixed to the seatback frame extending in the width direction at the first end and the second end over a predetermined length in the width direction. Therefore, the support stiffness of the first belt guide can be improved.

In the above aspect, the seatback may further comprise a second belt guide (52) which has a first end (52a) and a second end (52b) supported on the seatback frame at positions spaced from each other in the width direction and guides the belt at a position closer to the seat belt retractor than the first belt guide, wherein the first end and the second end of the second belt guide are positioned adjacent to and rearward of the first end and the second end of the first belt guide.

According to this aspect, due to the provision of the second belt guide, the force transmitted from the belt to the first belt guide is decreased. Therefore, when a large load is applied to the belt such as when the car collides head-on, deformation and fracture of the first belt guide can be suppressed. Also, since the first end and the second end of the second belt guide are disposed adjacent to the first end and the second end of the first belt guide, the support stiffness of the both belt guides can be improved.

In the above aspect, the seatback frame may comprise: a panel structure (17R) composed of a front panel (23) and a rear panel (24) which are joined to each other; a pair of pivot connection parts (18) provided on lower portions of respective side portions of the panel structure in the width direction and supported pivotably; and a reinforcement member (31) attached to the panel structure to extend from a vicinity of the pivot connection part on one side portion of the panel structure in the width direction to an upper portion of another side portion of the panel structure, wherein the support member is joined to the reinforcement member.

According to this aspect, since the support member is joined to the reinforcement member having high stiffness, the support stiffness of the support member and the first belt guide is improved.

### Effect of the Invention

One aspect of the present invention provides a seatback (5), comprising: a seatback frame (12R); a first belt guide (51) which has a first end (51a) and a second end (51b) supported on the seatback frame at positions spaced from each other in a width direction of the seatback frame and guides a belt (41) withdrawn from a seat belt retractor (42); and a support member (53) supporting an intermediate portion (51d) of the first belt guide between the first end and the second end from below.

According to this aspect, since the intermediate portion of the first belt guide is supported by the support member from below, the support stiffness of the first belt guide is improved. Therefore, a seatback in which the support stiffness of the first belt guide is improved can be provided.

In the above aspect, the support member may have a first fixing part (53a) and a second fixing part (53b) which are fixed to the seatback frame at positions spaced from each other in the width direction, the first fixing part is disposed more outward in the width direction than the first end of the first belt guide, and the second fixing part is disposed more outward with respect to the intermediate portion in the width direction than the second end of the first belt guide.

According to this aspect, since the support stiffness of the support member is improved, the support stiffness of the first belt guide supported by the support member is also improved.

In the above aspect, the support member may comprise: a wire member (54) including a first wire part (54a) and a second wire part (54b) extending in at least a vertical direction and a connecting wire part (54d) extending in at least the width direction and connecting the first wire part and the second wire part; and a connecting bracket (55) connecting the first wire part and the second wire part.

Here, extending “in at least the vertical direction” means that the extension direction of each wire part has a vertical component, and does not limit the extension direction of each wire part to the vertical direction. Also, extending “in at least the width direction” means that the extension direction of the connecting wire part has a component in the width direction, and does not limit the extension direction of the connecting wire part to the width direction. According to this aspect, due to the use of the wire member, the weight of the support member can be reduced, and due to the use of the connecting bracket, the stiffness of the support member can be improved.

In the above aspect, the connecting bracket may be connected to the first belt guide.

According to this aspect, the support stiffness of the first belt guide is further improved.

In the above aspect, the connecting bracket may include a fixing part (55b) that fixes an exterior cover (8, 11) of the seatback.

According to this aspect, the connecting bracket also functions as a fixing member for fixing the garnish in addition to as a reinforcement member for the support member. Therefore, it is unnecessary to separately provide a fixing member for the garnish, and an increase in the number of components can be suppressed.

In the above aspect, the seatback frame may be formed commonly for a center seat (2C) which is a seat on which the belt is to be fastened and for which the first belt guide is disposed in a position offset from a seat center in the width direction and a side seat (2R) disposed on a side of the center seat to which the first belt guide is offset, the seatback frame may include a headrest support (36) that supports a headrest (7R) of the side seat, and the connecting bracket may be connected to the headrest support.

According to this aspect, since the first belt guide is connected to the headrest support via the connecting bracket, the support stiffness of the first belt guide is further improved.

In the above aspect, lower ends of the first fixing part and the second fixing part of the support member are disposed in positions lower than an upper end of the seat belt retractor.

According to this aspect, the seat belt retractor is disposed in a high position overlapping the support member in the height direction. Thereby, the seatback can be made compact.

In the above aspect, the first belt guide may be made of a wire and the first end and the second end of the first belt guide may be bent to extend in the width direction along the seatback frame.

According to this aspect, even though the first belt guide is made of a wire, the first belt guide can be fixed to the seatback frame extending in the width direction at the first end and the second end over a predetermined length in the width direction. Therefore, the support stiffness of the first belt guide can be improved.

In the above aspect, the seatback may further comprise a second belt guide (52) which has a first end (52a) and a second end (52b) supported on the seatback frame at positions spaced from each other in the width direction and guides the belt at a position closer to the seat belt retractor than the first belt guide, wherein the first end and the second end of the second belt guide are positioned adjacent to and rearward of the first end and the second end of the first belt guide.

According to this aspect, due to the provision of the second belt guide, the force transmitted from the belt to the first belt guide is decreased. Therefore, when a large load is applied to the belt such as when the car collides head-on, deformation and fracture of the first belt guide can be suppressed. Also, since the first end and the second end of the second belt guide are disposed adjacent to the first end and the second end of the first belt guide, the support stiffness of the both belt guides can be improved.

In the above aspect, the seatback frame may comprise: a panel structure (17R) composed of a front panel (23) and a rear panel (24) which are joined to each other; a pair of pivot connection parts (18) provided on lower portions of respective side portions of the panel structure in the width direction and supported pivotably; and a reinforcement member (31) attached to the panel structure to extend from a vicinity of the pivot connection part on one side portion of the panel structure in the width direction to an upper portion of another side portion of the panel structure, wherein the support member is joined to the reinforcement member.

According to this aspect, since the support member is joined to the reinforcement member having high stiffness, the support stiffness of the support member and the first belt guide is improved.

### BRIEF DESCRIPTION OF THE DRAWINGS

FIG. 1 is a perspective view of a vehicle seat according to an embodiment;

FIG. 2 is a perspective view of the vehicle seat showing a seatback frame;

FIG. 3 is a schematic exploded view of a right panel structure of a right seatback;

FIG. 4 is a perspective view of the right panel structure of the right seatback;

FIG. 5 is a front view of an upper portion of the seatback frame of the right seatback;

FIG. 6 is a perspective view of a main part of the right seatback as viewed from the front;

FIG. 7 is a view of the right seatback as viewed from the rear;

FIG. 8 is a perspective view of an upper portion of the right seatback as viewed from the upper rear;

FIG. 9 is a sectional view of the right seatback taken along line IX-IX in FIG. 5.

### DETAILED DESCRIPTION OF THE INVENTION

In the following, an embodiment in which the present invention is applied to a car seat 1 which is an example of a vehicle seat will be described with reference to the drawings.

The car seat 1 in the embodiment is a three-seater rear seat installed in the second row of an automobile. In the following, based on the traveling direction of the automobile, the three seats 2 (2R, 2C, 2L) of the car seat 1 will be referred to as the right seat 2R, the center seat 2C, and the left seat 2L. The center seat 2C is disposed at the center in the width direction of the automobile, and the right seat 2R and the left seat 2L are side seats disposed on both sides of the center seat 2C. When they are collectively referred to or when they are not distinguished from each other, they may be simply referred to as the seats 2.

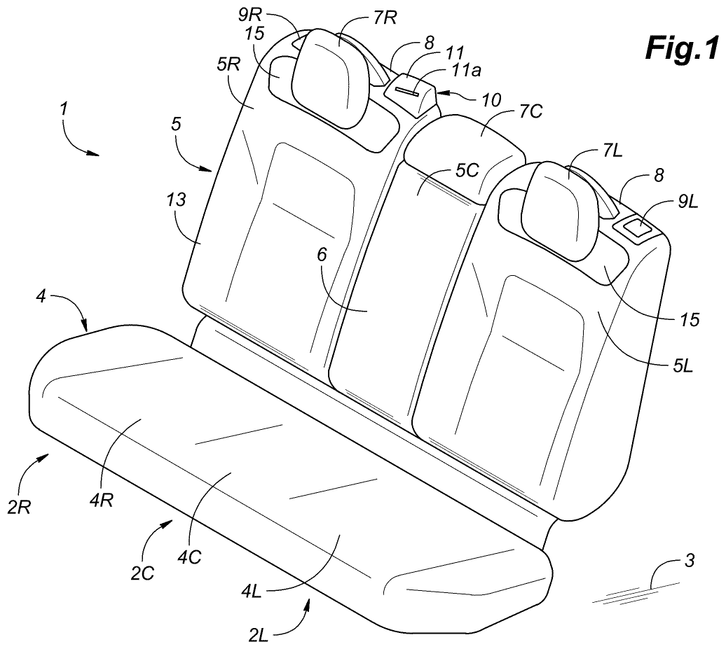

FIG. 1 is a perspective view of a car seat 1 according to an embodiment. As shown in FIG. 1, the car seat 1 includes a seat cushion 4 supported on a body of the automobile (hereinafter referred to as the vehicle body 3) to support the occupant's buttocks from below and a seatback 5 for supporting the occupant's back from the rear. The seat cushion 4 is a component manufactured commonly for the three seats 2 and includes a right cushion part 4R for the right seat 2R, a center cushion part 4C for the center seat 2C, and a left cushion part 4L for the left seat 2L. The seat cushion 4 is fixed to the floor which is a part of the vehicle body 3.

The seatback 5 is a two-piece type divided between left and right so that the ratio of the right part to the left part is 6/4, and includes a right seatback 5R and a left seatback 5L. The right seatback 5R integrally includes a right seatback part for the right seat 2R and a center seatback part 5C for the center seat 2C. Namely, the right seatback 5R is formed commonly for the right seat 2R and the center seat 2C. The left seatback 5L is configured as a left seatback part for the left seat 2L. The right seatback 5R and the left seatback 5L are pivotably supported.

The right seatback 5R and the left seatback 5L are configured to pivot between a standing position for seating as shown in FIG. 1 and a folded position which is pivoted forward from the standing position. When in the standing position, upper portions of the right seatback 5R and the left seatback 5L are fixed to the vehicle body 3 so that they do not pivot forward. When the right seatback 5R and the left seatback 5L are in the folded position, the space above the right seatback 5R and the left seatback 5L may be used as a cargo room extension that extends the cargo room provided behind the seats 2 forward.

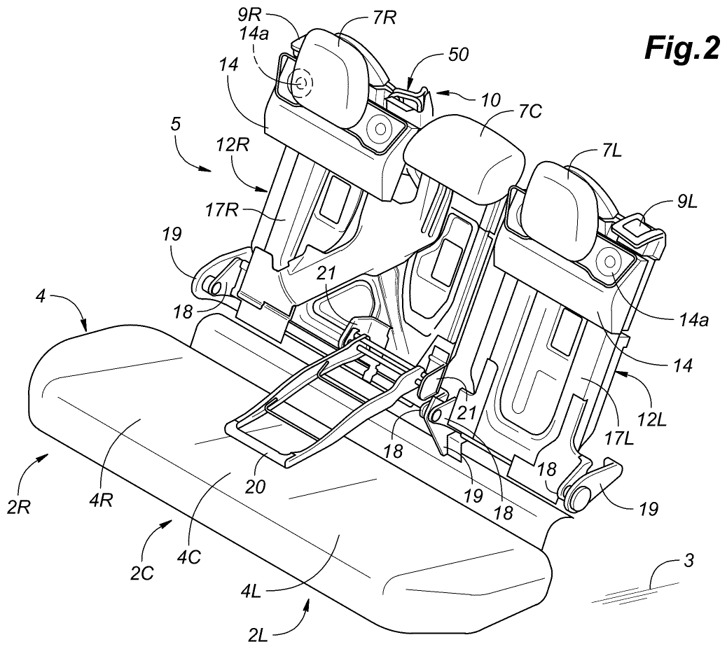

In a front portion of the center seatback part 5C of the right seatback 5R, an accommodation recess in which an armrest 6 is disposed is formed to be recessed rearward. The armrest 6 is disposed in the accommodation recess and is supported at the lower portion thereof on the right seatback 5R to be pivotable about a rotation axis extending laterally. The armrest 6 includes a base end portion supported on the seatback 5 and a tip end portion remote from the base end portion, and is configured to pivot between an accommodation position (the position in FIG. 1) in which the tip end portion is positioned in an upper portion of the accommodation recess and a use position (see FIG. 2) in which the tip end portion is positioned in front of the base end portion. The armrest 6 constitutes substantially the whole front surface of the center seatback part 5C.

An upper portion of the right seatback 5R is provided with a right headrest 7R for the right seat 2R and a center headrest 7C for the center seat 2C so that their vertical positions can be changed. An upper portion of the left seatback 5L is provided with a left headrest 7L for the left seat 2L so that its vertical position thereof can be changed. FIG. 1 shows a state in which each headrest is in the lowermost position. In this state, the right headrest 7R and the left headrest 7L protrude upward from the upper ends of the corresponding seatbacks 5 relatively largely. The center headrest 7C is configured not to protrude from the upper end of the right seatback 5R.

The upper portions of the right seatback 5R and the left seatback 5L are provided with an exterior cover member 8 made of resin. On a part of the upper end of the right seatback 5R on the right side of the right headrest 7R, a right seatback release lever 9R for releasing the fixation of the right seatback 5R in the standing position to the vehicle body 3 is provided. On a part of the upper end of the left seatback 5L on the left side of the left headrest 7L, a left seatback release lever 9L for releasing the fixation of the left seatback 5L in the standing position to the vehicle body 3 is provided.

On a part of the upper end of the right seatback 5R on the left side of the right headrest 7R, a belt garnish 11 which is an exterior cover made of resin and forming a belt outlet 11a of a seat belt device 10 for the center seat 2C is provided. The configuration of the seat belt device 10 will be described later.

A belt outlet of a seat belt device for the right seat 2R is formed in an interior resin component (not shown in the drawings) disposed on the right side of the right seatback 5R and functioning as a bolster. A belt retractor for the right seat 2R is disposed inside the interior resin component and is fixed to the vehicle body 3 via a bracket. The configuration related to the seat belt for the left seat 2L differs from that for the right seat 2R in that they are bilaterally symmetrical with each other, and is otherwise the same.

FIG. 2 is a perspective view of the car seat 1 showing a frame of the seatback 5 (hereinafter referred to as the seatback frame 12 (12R, 12L)). As shown in FIG. 2, the seatback 5 includes a seatback frame 12, a pad (not shown in the drawings) having flexibility and supported on the seatback frame 12, and a skin member 13 (see FIG. 1) covering the pad. The pad is preferably formed of urethane foam, for example. The skin member 13 is preferably formed of a flexible sheet material, such as artificial or synthetic leather, natural leather, fabric, for example.

The upper portions of the right seatback 5R and the left seatback 5L are internally provided with speaker devices 14. Each speaker device 14 includes a pair of speakers 14a disposed on both sides of the right headrest 7R or the left headrest 7L corresponding thereto. Front surfaces of the pair of speaker devices 14 are provided with speaker grilles 15 (FIG. 1).

A part of the seatback frame 12 for the right seatback 5R (hereinafter referred to as the right seatback frame 12R) is formed commonly for the center seat 2C and the right seat 2R, which is disposed on the right side of the center seat 2C. The right seatback frame 12R includes a right panel structure 17R having a rectangular plate shape and left and right pivot connection parts 18 integrally provided on both side portions (more specifically, on right and left ends) of a lower part of the right panel structure 17R. The left and right pivot connection parts 18 are pivotably supported by vehicle body-side support members 19 fixed to the vehicle body 3, whereby the right seatback frame 12R is supported to be pivotable about an axis extending in the vehicle width direction.

A part of the seatback frame 12 for the left seatback 5L (hereinafter referred to as the left seatback frame 12L) includes a left panel structure 17L having a vertically elongated rectangular plate shape and left and right pivot connection parts 18 integrally provided on right and left ends of a lower part of the left panel structure 17L. The left and right pivot connection parts 18 are pivotably supported by vehicle body-side support members 19 fixed to the vehicle body 3, whereby the left seatback frame 12L is supported to be pivotable about an axis extending in the vehicle width direction. The left pivot connection part 18 of the right seatback frame 12R and the right pivot connection part 18 of the left seatback frame 12L are arranged to interpose one vehicle body-side support member 19 therebetween and are supported by the common vehicle body-side support member 19.

A lower portion of a part of the right seatback frame 12R constituting the center seatback part 5C is integrally provided with left and right armrest brackets 21 to support the frame of the armrest 6 (hereinafter referred to as the armrest frame 20). The armrest frame 20 has an elongated rectangular frame shape and is supported, at the lower end or the rear end thereof, by the left and right armrest brackets 21 to be pivotable about an axis extending in the vehicle width direction.

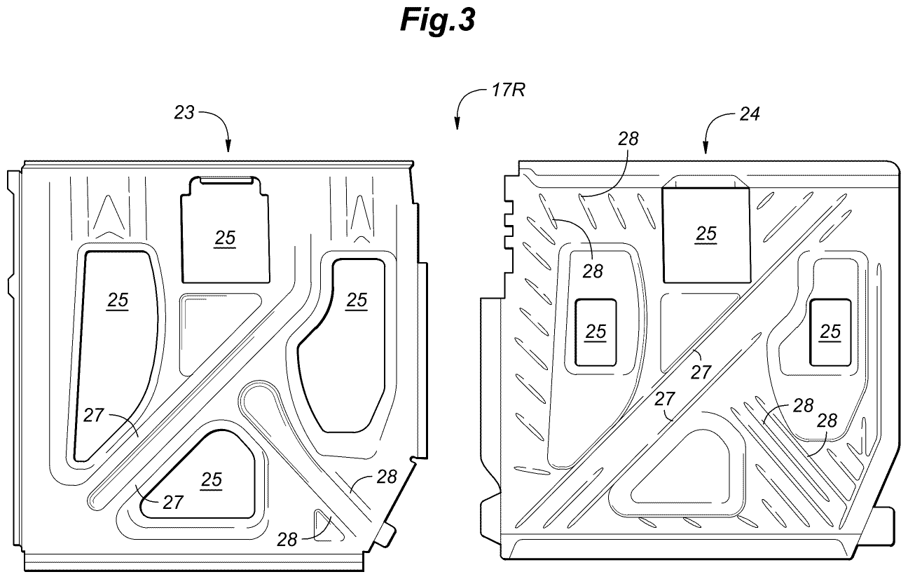

FIG. 3 is a schematic exploded view of the right panel structure 17R of the right seatback 5R. As shown in FIG. 3, the right panel structure 17R includes, as main components thereof, a front panel 23 and a rear panel 24 which are made of steel and are joined to each other in an overlapping state to constitute the structural body. The front panel 23 and the rear panel 24 have outer contours with substantially the same size. The front panel 23 and the rear panel 24 may be joined to each other by laser welding, gas welding, spot welding, etc., for example. In the following, unless otherwise mentioned, “being joined” means that the joining is achieved by any of these.

The rear panel 24 is provided with relatively small three openings 25 at the center of an upper portion and in left and right parts of an intermediate position in the height direction. The rear panel 24 has two oblique large ribs 27 continuously extending from the right lower portion to the left upper portion in an inclined manner. The right upper portion and the left lower portion of the rear panel 24 are formed with multiple oblique small ribs 28 which are inclined in the direction opposite to the inclination direction of the oblique large ribs 27. The oblique large ribs 27 and the oblique small ribs 28 are formed to be convex forward by press-forming a steel plate.

The front panel 23 is provided with relatively large four openings 25 at the center of an upper portion, at the center of a lower portion, and in left and right parts of an intermediate position in the height direction. The front panel 23 has two oblique large ribs 27 continuously extending from the right lower portion to the left upper portion in an inclined manner. The left lower portion of the front panel 23 is formed with two oblique small ribs 28 which are inclined in the direction opposite to the inclination direction of the oblique large ribs 27. The oblique large ribs 27 and the oblique small ribs 28 are formed to be convex forward by press-forming a steel plate.

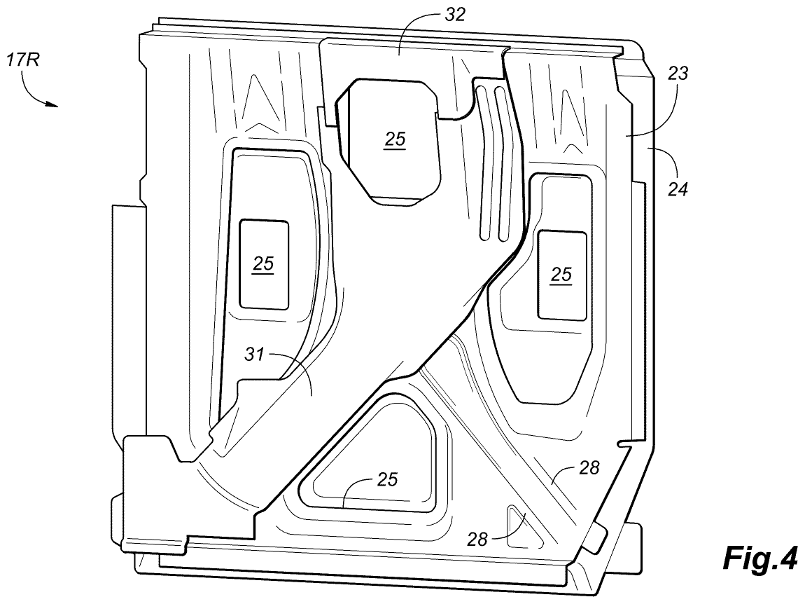

FIG. 4 is a perspective view of the right panel structure 17R of the right seatback 5R. As shown in FIG. 4, the right panel structure 17R is further provided with a first reinforcement plate 31 and a second reinforcement plate 32 as reinforcement members in addition to the front panel 23 and the rear panel 24. The first reinforcement plate 31 has a size and a shape to cover the oblique large ribs 27 of the front panel 23 and to surround a lower portion of the opening 25 at the center of the upper portion of the front panel 23. Namely, the first reinforcement plate 31 is attached to the right panel structure 17R so as to extend from one side portion of the right panel structure 17R (more specifically, from the vicinity of the pivot connection part 18 (FIG. 2) at the right end of the lower portion of the right panel structure 17R) to the other side portion (more specifically, the left upper portion) of the right panel structure 17R. The first reinforcement plate 31 is attached to the front surface of the front panel 23. The second reinforcement plate 32 has a size and a shape to surround an upper part of the opening 25 at the center of the upper portion of the front panel 23 and, in cooperation with the first reinforcement plate 31, to surround the entire circumference of the opening 25. The second reinforcement plate 32 is attached to the front surface of the front panel 23 and the front surface of the first reinforcement plate 31.

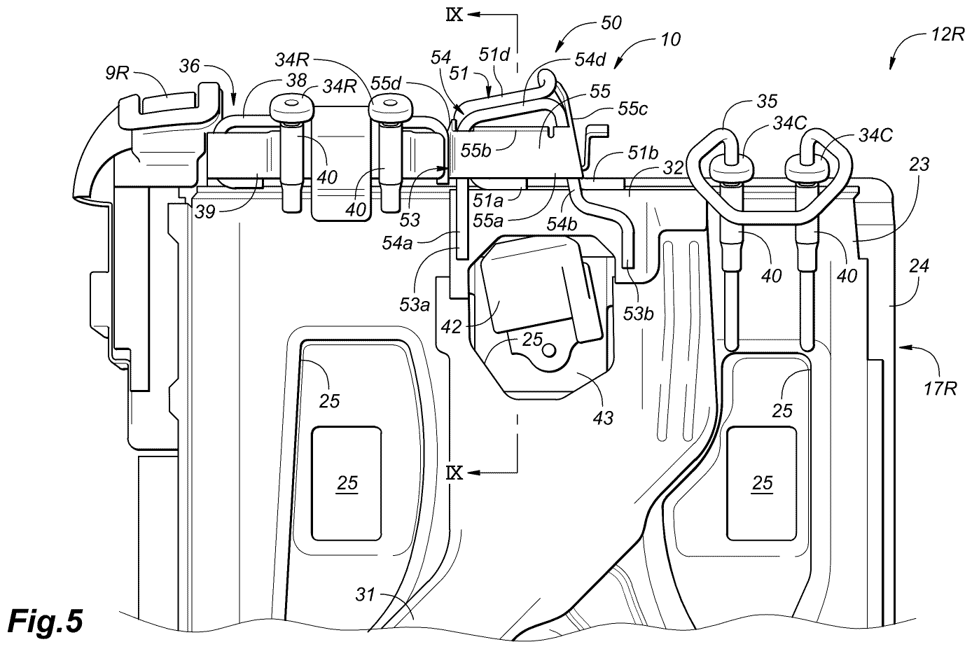

FIG. 5 is a front view of an upper portion of the seatback frame 12R for the right seatback 5R. As shown in FIG. 5, the upper portion of the right panel structure 17R is provided with a pair of right headrest guides 34R for supporting the pillar of the right headrest 7R and a pair of center headrest guides 34C for supporting a center pillar 35 of the center headrest 7C. The pair of right headrest guides 34R and the pair of center headrest guides 34C are made of resin.

The pair of right headrest guides 34R are supported on the right panel structure 17R via a headrest support 36 made of steel. The headrest support 36 includes a support wire 38, a connecting plate 39, and a pair of stays 40 which are tubular in shape and hold the right headrest guides 34R. The support wire 38 has an inverted U shape and is fixed to the upper portion of the right panel structure 17R. The connecting plate 39 connects the leg portions of the support wire 38. The pair of stays 40 are fixed to the connecting plate 39. The pair of center headrest guides 34C are supported on the right panel structure 17R via a pair of stays 40 which are made of steel, fixed to the upper portion of the right panel structure 17R, and hold the center headrest guides 34C.

Next, the seat belt device 10 will be described. The seat belt device 10 includes a seat belt retractor 42 for winding up a belt 41. The seat belt retractor 42 is disposed in a position behind the right panel structure 17R and aligned with the upper center opening 25 and is mounted to the right panel structure 17R via a support bracket 43. On the upper portion of the right panel structure 17R and in a position aligned with the seat belt retractor 42 in the width direction of the seatback frame 12, a belt guide mechanism 50 for guiding the belt 41 is provided. The belt guide mechanism 50 is disposed in a position that is offset to the right in the width direction from the seat center of the center seat 2C on which the belt 41 is to be fastened.

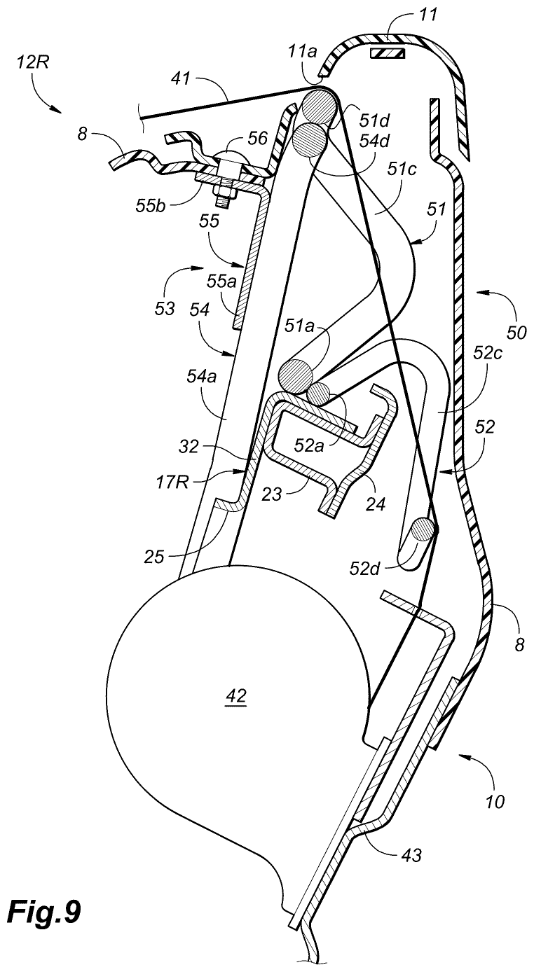

FIG. 9 is a sectional view of the right seatback 5R taken along line IX-IX in FIG. 5. As shown in FIG. 9, the belt 41 is drawn out upward from the seat belt retractor 42, extends upward behind the right panel structure 17R, and is bent forward to be drawn out forward and downward from the right panel structure 17R. In the state fixed to the right seatback frame 12R via the support bracket 43, the seat belt retractor 42 extends through the opening 25 at the center of the upper portion of the right panel structure 17R in the front-rear direction. Thereby, rearward protrusion of the seat belt retractor 42 is suppressed.

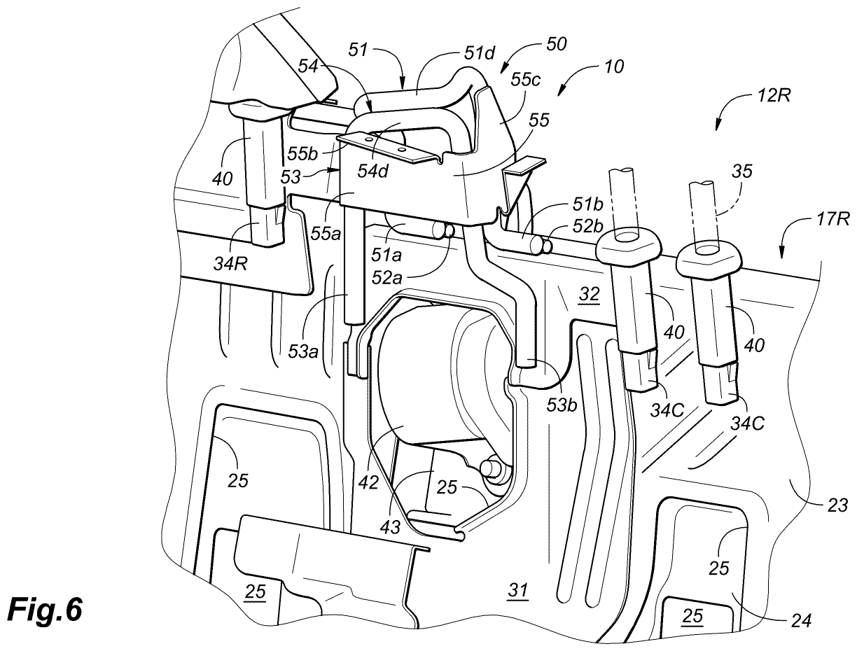

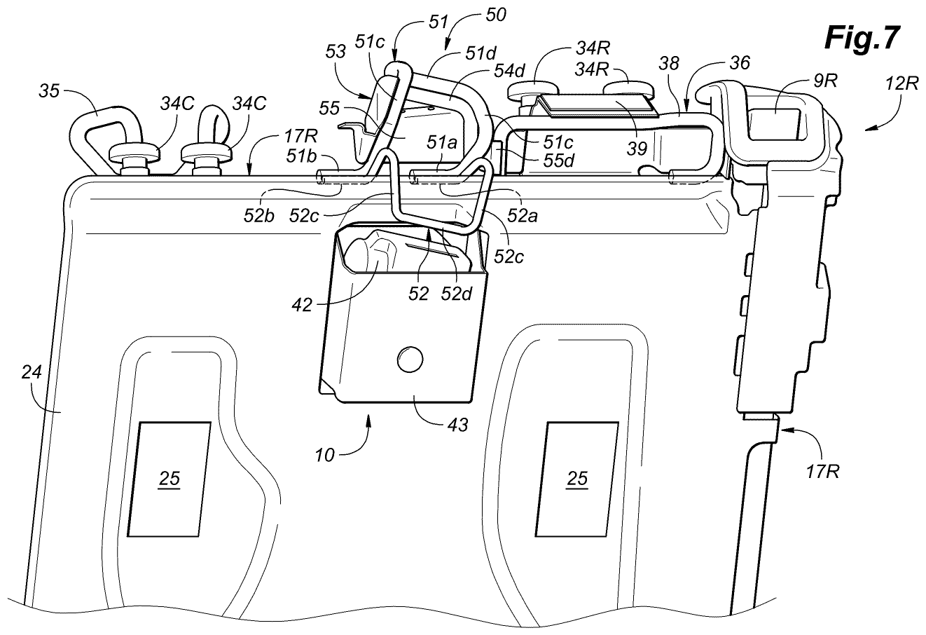

FIG. 6 is a perspective view of a main part of the right seatback 5R as viewed from the front, and FIG. 7 is a view of the right seatback 5R as viewed from the rear. As shown in FIG. 5 to FIG. 7, the belt guide mechanism 50 includes a first belt guide 51 and a second belt guide 52 each guiding the belt 41 and a support member 53 supporting the first belt guide 51. The first belt guide 51 supports the belt 41 above the right panel structure 17R. The second belt guide 52 supports the belt 41 behind the right panel structure 17R. The support member 53 supports the first belt guide 51 from below.

The first belt guide 51 is formed by bending a wire in a predetermined shape. The first belt guide 51 has a first end (right end) 51a and a second end (left end) 51b supported on the upper surface of the right panel structure 17R (specifically, the upper surface of the second reinforcement plate 32) at positions spaced from each other in the width direction. Further, the first belt guide 51 includes a pair of leg portions 51c extending upward from the first end 51a and the second end 51b and an intermediate portion 51d connecting the pair of leg portions 51c. The intermediate portion 51d extends substantially horizontally above the first end 51a and the second end 51b and contacts the belt 41 drawn out from the seat belt retractor 42 to guide the belt 41. Note, however, that the intermediate portion 51d of the first belt guide 51 is tilted downward toward the right to guide the belt 41 to be drawn out diagonally over the center seat 2C, namely, obliquely from the right upper portion to the left lower portion of the center seatback part 5C.

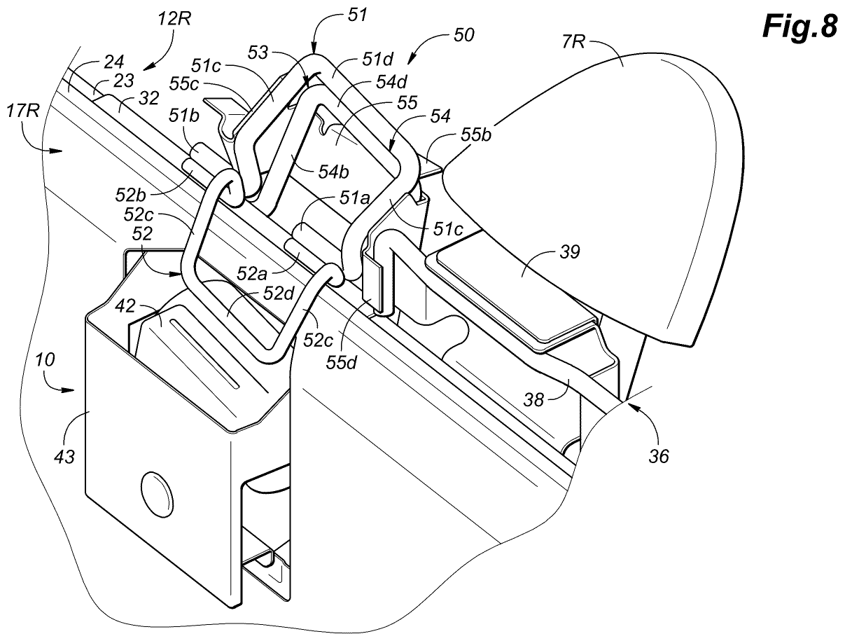

FIG. 8 is a perspective view of an upper portion of the right seatback 5R as viewed from the upper rear. As shown in FIG. 7 and FIG. 8, the second belt guide 52 is formed by bending a wire in a predetermined shape. The second belt guide 52 has a first end (right end) 52a and a second end (left end) 52b supported on the right panel structure 17R at positions spaced from each other in the width direction. Further, the second belt guide 52 includes a pair of leg portions 52c extending obliquely downward and rearward in a curved manner from the first end 52a and the second end 52b and an intermediate portion 52d connecting the pair of leg portions 52c. The intermediate portion 52d extends substantially horizontally behind the first end 52a and the second end 52b and contacts the belt 41 drawn out from the seat belt retractor 42 to guide the belt 41. Note, however, that the intermediate portion 52d of the second belt guide 52 is tilted downward toward the right for the same reason as for the intermediate portion 51d of the first belt guide 51.

As shown in FIG. 5 and FIG. 6, the support member 53 includes a wire member 54 composed of a wire and a connecting bracket 55 composed of a steel plate. The wire member 54 is formed by bending the wire in a predetermined shape. The wire member 54 includes a first wire part 54a and a second wire part 54b which extend at least in the vertical direction and have lower ends fixed to the front surface of the right panel structure 17R (specifically, the front surface of the second reinforcement plate 32) at positions spaced from each other in the width direction and a connecting wire part 54d connecting these wire parts. The connecting wire part 54d extends in at least the width direction and, in the present embodiment, extends in parallel with the intermediate portion 51d of the first belt guide 51. The connecting wire part 54d is disposed below the intermediate portion 51d of the first belt guide 51 and, in the state contacting the intermediate portion 51d, is joined to the intermediate portion 51d. The lower ends of the first wire part 54a and the second wire part 54b of the support member 53 form a first fixing part 53a and a second fixing part 53b for fixing the support member 53 to the right seatback frame 12R.

The connecting bracket 55 is formed by press-working a steel plate. The connecting bracket 55 is joined to the first wire part 54a and the second wire part 54b of the wire member 54 and connects them. As shown in FIG. 9, the connecting bracket 55 includes a main part 55a extending in the up-down direction and the width direction and a fixing part 55b extending forward from an upper portion of the main part 55a to fix other components. The fixing part 55b of the connecting bracket 55 is formed with through holes, and the exterior cover member 8 and the belt garnish 11 are fixed to the fixing part 55b by fastening members 56 inserted in the through holes and are supported on the left panel structure 17L via the connecting bracket 55. In the present embodiment, the fastening members 56 are composed of bolts and nuts. The fastening members 56 may be fasteners or clips.

As shown in FIG. 6 and FIG. 8, the connecting bracket 55 includes a left extension part 55c extending rearward from the left end of the main part 55a. The left extension part 55c is joined to the left leg portion 51c of the first belt guide 51. As shown in FIG. 7 and FIG. 8, the connecting bracket 55 includes a right extension part 55d extending rearward from the right end of the main part 55a. The right extension part 55d is joined to the support wire 38 of the headrest support 36 of the right seat 2R.

The car seat 1 according to the embodiment is configured as described above. Next, the effects of the seatback 5 thus configured will be described.

As shown in FIG. 5 and FIG. 6, the first belt guide 51 includes the first end 51a and the second end 51b supported on the right seatback frame 12R at positions spaced from each other in the width direction of the right seatback frame 12R and guides the belt 41 (FIG. 9) withdrawn from the seat belt retractor 42. Further, the seatback 5 includes the support member 53 supporting the intermediate portion 51d between the first end 51a and the second end 51b of the first belt guide 51 from below. Thereby, since the intermediate portion 51d of the first belt guide 51 is supported by the support member 53 from below, the support stiffness of the first belt guide 51 is improved.

As shown in FIG. 5, the support member 53 has the first fixing part 53a and the second fixing part 53b which are fixed to the right seatback frame 12R at positions spaced from each other in the width direction. The first fixing part 53a is disposed more outward in the width direction than the first end 51a of the first belt guide 51, and the second fixing part 53b is disposed more outward with respect to the intermediate portion 51d in the width direction than the second end 51b of the first belt guide 51. Thereby, since the support stiffness of the support member 53 is improved, the support stiffness of the first belt guide 51 supported by the support member 53 is also improved.

The support member 53 includes the wire member 54 and the connecting bracket 55. The wire member 54 includes the first wire part 54a and the second wire part 54b extending in at least the vertical direction and the connecting wire part 54d extending in at least the width direction and connecting the first wire part 54a and the second wire part 54b. The connecting bracket 55 connects the first wire part 54a and the second wire part 54b. By using the wire member 54 in this way, the weight of the support member 53 can be reduced, and due to the use of the connecting bracket 55, the stiffness of the support member 53 can be improved.

As shown in FIG. 6 and FIG. 8, the connecting bracket 55 is connected to the first belt guide 51. Therefore, the support stiffness of the first belt guide 51 is further improved.

As shown in FIG. 6 and FIG. 9, the connecting bracket 55 includes the fixing part 55b that fixes the exterior cover of the seatback 5 such as the exterior cover member 8 and the belt garnish 11. In other words, the connecting bracket 55 also functions as a fixing member for fixing the garnish in addition to as a reinforcement member for the support member 53. Therefore, it is unnecessary to separately provide a fixing member for the garnish, and thus, an increase in the number of components can be suppressed.

As shown in FIG. 2, the right seatback frame 12R is formed commonly for the center seat 2C on which the belt 41 is to be fastened and for which the first belt guide 51 is disposed in a position offset from a seat center in the width direction and the right seat 2R disposed on the side of the center seat 2C to which the first belt guide 51 is offset. As shown in FIG. 5, the right seatback frame 12R includes the headrest support 36 that supports the right headrest 7R of the right seat 2R. As shown in FIG. 7 and FIG. 8, the connecting bracket 55 is connected to the headrest support 36. In this way, since the first belt guide 51 is connected to the headrest support 36 via the connecting bracket 55, the support stiffness of the first belt guide 51 is further improved.

As shown in FIG. 5 and FIG. 9, the lower ends of the first fixing part 53a and the second fixing part 53b of the support member 53 are disposed in positions lower than the upper end of the seat belt retractor 42. In other words, the seat belt retractor 42 is disposed in a high position overlapping the support member 53 in the height direction. Thereby, the seatback 5 can be made compact.

As shown in FIG. 6 and FIG. 7, the first belt guide 51 is made of a wire and the first end 51a and the second end 51b of the first belt guide 51 are bent to extend in the width direction along the right seatback frame 12R. Thereby, even though the first belt guide 51 is made of a wire, the first belt guide 51 can be fixed to the right seatback frame 12R extending in the width direction at the first end 51a and the second end 51b over a predetermined length in the width direction. Therefore, the support stiffness of the first belt guide 51 is improved.

As shown in FIG. 7 to FIG. 9, the seatback 5 includes the second belt guide 52 for guiding the belt 41 at a position closer to the seat belt retractor 42 than the first belt guide 51. The second belt guide 52 has the first end 52a and the second end 52b supported on the right seatback frame 12R at positions spaced from each other in the width direction. The first end 52a and the second end 52b of the second belt guide 52 are positioned adjacent to and rearward of the first end 51a and the second end 51b of the first belt guide 51. Due to the provision of the second belt guide 52 as above, the force transmitted from the belt 41 to the first belt guide 51 is decreased. Therefore, when a large load is applied to the belt 41 such as when the car collides head-on, deformation and fracture of the first belt guide 51 can be suppressed. Also, since the first end 52a and the second end 52b of the second belt guide 52 are disposed adjacent to the first end 51a and the second end 51b of the first belt guide 51, the support stiffness of the both belt guides can be improved.

As shown in FIG. 2 to FIG. 4, the right panel structure 17R is composed of the front panel 23 and the rear panel 24 which are joined to each other, and the pair of pivot connection parts 18 are provided on lower portions of respective side portions of the right panel structure 17R in the width direction and are supported pivotably. The right seatback frame 12R is provided with the first reinforcement plate 31 and the second reinforcement plate 32 which are reinforcement members attached to the right panel structure 17R to extend from the vicinity of the pivot connection part 18 on one side portion of the right panel structure 17R in the width direction to the upper portion of the other side portion of the right panel structure 17R. Further, as shown in FIG. 5, the support member 53 is joined to the second reinforcement plate 32. In this way, the support member 53 is joined to the second reinforcement plate 32 having high stiffness, and thus, the support stiffness of the support member 53 and the first belt guide 51 is improved.

Concrete embodiments have been described in the foregoing, but the present invention can be modified in various ways without being limited to the above embodiments.

In the above embodiment, the first reinforcement plate 31 and the second reinforcement plate 32, which are reinforcement members attached to the right panel structure 17R, are composed of separate members, but they may be configured as a single plate member. Also, the first end 52a and the second end 52b of the second belt guide 52 may be disposed in positions spaced from the first end 51a and the second end 51b of the first belt guide 51. The second belt guide 52 may be omitted. Further, the seat belt retractor 42 may be disposed in a position lower than the lower end of the support member 53.

As shown in FIG. 2, in the present embodiment, the right seatback frame 12R is formed commonly for the center seat 2C and the right seat 2R. In another embodiment, the right seatback frame 12R may be formed for the right seat 2R, and the left seatback frame 12L may be formed commonly for the center seat 2C and the left seat 2L. In this case, the seat belt retractor 42 and the belt guide mechanism 50 may be disposed on the right side of the headrest support 36 supporting the left headrest 7L in the left seatback frame 12L, instead of the right seatback frame 12R.

Also, though the support member 53 which supports the first belt guide 51 from below includes the wire member 54 and the connecting bracket 55, it may be composed of only the wire member 54 or may be composed of only a plate member without including the wire member 54. In this case also, the support member 53 preferably has a first fixing part 53a and a second fixing part 53b fixed to the right seatback frame 12R at positions spaced from each other in the width direction. Note, however, that the first fixing part 53a and the second fixing part 53b of the support member 53 may be disposed inward of the first end 51a and the second end 51b of the first belt guide 51 in the width direction.

1. A seatback, comprising:
a seatback frame;
a first belt guide which has a first end and a second end supported on the seatback frame at positions spaced from each other in a width direction of the seatback frame and guides a belt withdrawn from a seat belt retractor; and
a support member supporting an intermediate portion of the first belt guide between the first end and the second end from below.

2. The seatback according to claim 1, wherein the support member has a first fixing part and a second fixing part which are fixed to the seatback frame at positions spaced from each other in the width direction,
the first fixing part is disposed more outward in the width direction than the first end of the first belt guide, and
the second fixing part is disposed more outward with respect to the intermediate portion in the width direction than the second end of the first belt guide.

3. The seatback according to claim 1, wherein the support member comprises:
a wire member including a first wire part and a second wire part extending in at least a vertical direction and a connecting wire part extending in at least the width direction and connecting the first wire part and the second wire part; and
a connecting bracket connecting the first wire part and the second wire part.

4. The seatback according to claim 3, wherein the connecting bracket is connected to the first belt guide.

5. The seatback according to claim 3, wherein the connecting bracket includes a fixing part that fixes an exterior cover of the seatback.

6. The seatback according to claim 3, wherein the seatback frame is formed commonly for a center seat which is a seat on which the belt is to be fastened and for which the first belt guide is disposed in a position offset from a seat center in the width direction and a side seat disposed on a side of the center seat to which the first belt guide is offset,
the seatback frame includes a headrest support that supports a headrest of the side seat, and
the connecting bracket is connected to the headrest support.

7. The seatback according to claim 2, wherein lower ends of the first fixing part and the second fixing part of the support member are disposed in positions lower than an upper end of the seat belt retractor.

8. The seatback according to claim 1, wherein the first belt guide is made of a wire and the first end and the second end of the first belt guide are bent to extend in the width direction along the seatback frame.

9. The seatback according to claim 1, further comprising a second belt guide which has a first end and a second end supported on the seatback frame at positions spaced from each other in the width direction and guides the belt at a position closer to the seat belt retractor than the first belt guide,
wherein the first end and the second end of the second belt guide are positioned adjacent to and rearward of the first end and the second end of the first belt guide.

10. The seatback according to claim 1, wherein the seatback frame comprises:
a panel structure composed of a front panel and a rear panel which are joined to each other;
a pair of pivot connection parts provided on lower portions of respective side portions of the panel structure in the width direction and supported pivotably; and
a reinforcement member attached to the panel structure to extend from a vicinity of the pivot connection part on one side portion of the panel structure in the width direction to an upper portion of another side portion of the panel structure,
wherein the support member is joined to the reinforcement member.
